(19) United States
(12) Patent Application Publication
(10) Pub. No.: US 2017/0014287 A1
(43) Pub. Date: Jan. 19, 2017

(54) Pull-type Body Turning Aid and Pull-type Body Turning Device Including the Same

(71) Applicants: Tai-Tien Chung, (US); Chuan-Tsai Lin, (US)

(72) Inventors: Tai-Tien Chung, Chiayi City (TW); Chuan-Tsai Lin, Changhua City (TW); Yu-Ruei Lin, Changhua City (TW)

(21) Appl. No.: 15/210,294

(22) Filed: Jul. 14, 2016

(30) Foreign Application Priority Data
Jul. 17, 2015 (TW) 104123277
May 17, 2016 (TW) 105115142

(51) Int. Cl. A61G 7/00; A61G 7/10

(52) U.S. Cl. CPC A61G 7/001; A61G 7/1015; A61G 7/1046; A61G 7/1042; A61G 7/1051

(57) ABSTRACT

A pull-type body turning aid includes a slide rail unit and a drive mechanism. The slide rail unit is disposed above a patient and has at least one slide rail assembly. The slide rail assembly includes a slide rail having a length extending across the patient, and a sliding block slidable along the slide rail and connected to one side of the patient. The drive mechanism is connected to the slide rail assembly and is configured to drive the sliding block to move along the slide rail from the one side of the patient to the other side thereof for turning the patient to the other side thereof.

### CROSS-REFERENCE TO RELATED APPLICATION

This application claims priorities to Taiwanese Patent Application No. 104123277, filed on Jul. 17, 2015, and Taiwanese Patent Application No. 105115142, filed on May 17, 2016.

### FIELD

The disclosure relates to a turning aid, and more particularly to a pull-type body turning aid and a pull-type body turning device including the same.

### BACKGROUND

Because a bedridden patient is in long term contact with a mattress, the circulatory system of the patient is poor due to the compression between a body portion of the patient and the mattress. In addition, the bedridden patient may suffer from bedsores due to humidity accumulated in the mattress To prevent the bedsores, a healthcare provider has to turn the patient or pat his/her back. Such method is labor intensive

In order to improve the aforesaid problems, relevant products have been introduced into the market. Commonly seen are air-inflatable cushions oriented between the body of the bedridden patient and the mattress to thereby change the pressure points of the bedridden patient. Another way is to :provide a mattress assembly including a plurality of bed plates that are movable upward and downward to change the pressure points of the bedridden patient. However, the mattress assembly cannot perform effective turning of the bedridden patient so as to move the back of the bedridden patient away from the mattress assembly. As a result, the healthcare provider still has to periodically and manually turn the bedridden patient, and the labor cost problems still exist.

### SUMMARY

Therefore, an object of the disclosure is to provide a pull-type body turning aid that can save labor costs.

According to one aspect of the disclosure, a pull-type body turning aid for turning a patient includes at least one slide rail unit and a drive mechanism.

The slide rail unit is configured to be disposed above the patient and has at least one slide rail assembly. The slide rail assembly includes a slide rail having a length configured to extend across the patient, and a sliding block slidable along the slide rail and configured to be connected to one slide of the patient.

The drive mechanism is connected to the slide rail assembly and is configured to drive the sliding block to move along the slide rail from the one side of the patient to the other side thereof for turning the patient to the other side thereof.

Another object of the disclosure is to provide a pull-type body turning device that can save labor costs.

According to another aspect of the disclosure, a pull-type body turning device includes a bed assembly and a pull-type body turning aid.

The bed assembly is configured to support the patient.

The pull-type body turning aid is movable relative to the bed assembly and includes at least one slide rail unit and a drive mechanism.

The slide rail unit is configured to be disposed above the patient and has at least one slide rail assembly. The slide rail assembly includes a slide rail having a length configured to extend across the patient, and a sliding block slidable along the slide rail and configured to be connected to one side of the patient.

The drive mechanism is connected to the slide rail assembly and is configured to drive the sliding block to move along the slide rail from the one side of the patient to the other side thereof for turning the patient to the other side thereof.

### BRIEF DESCRIPTION OF THE DRAWINGS

Other features and advantages of the disclosure will become apparent in the following detailed description of the embodiments with reference to the accompanying drawings, of which:

FIG. 1 is a top view of a pull-type body turning device according to a first embodiment of the present disclosure being used on a patient;

FIG. 2 is a front view of FIG. 1;

FIG. 3 is a schematic view of an upper body strap unit and a lower body strap unit of a strap assembly of the first embodiment;

FIG. 4 is a view similar to FIG. 1, but illustrating the patient being turned by a pull-type body turning aid of the first embodiment to a lateral decubitus position;

FIG. 5 is a top view, illustrating the body turning aid of the first embodiment being moved rearwardly away from the patient;

FIG. 6 is a partly sectional view of a pull-type body turning device according to a second embodiment of the present disclosure;

FIG. 7 is a fragmentary top view of the second embodiment; and

FIG. 8 is a top view of a pull-type body turning device according to a third embodiment of the present disclosure being used on a patient

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

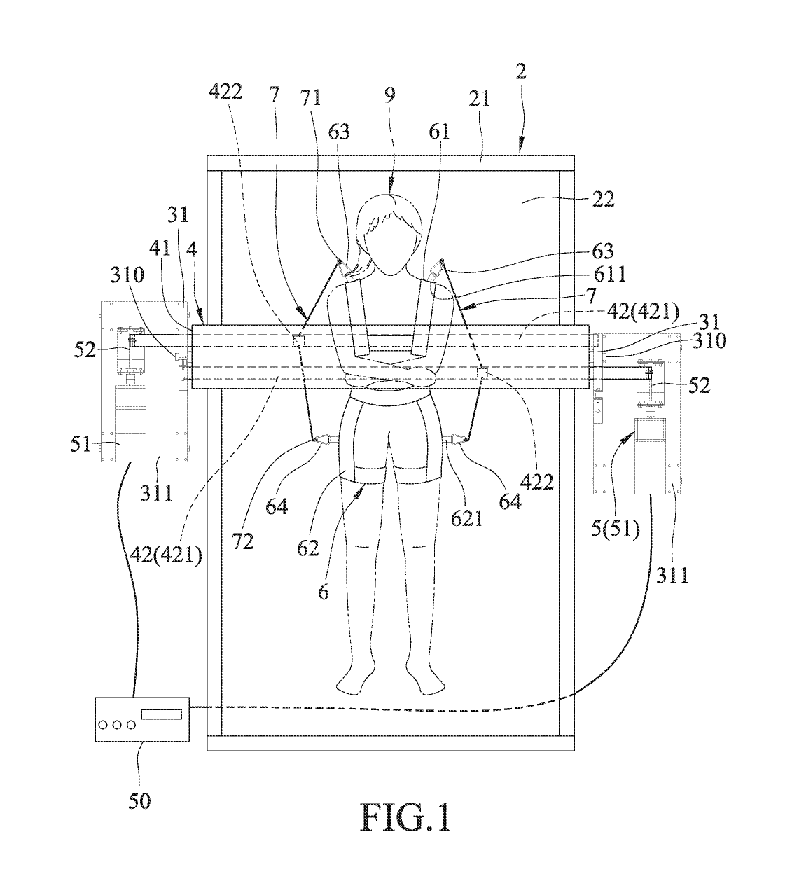

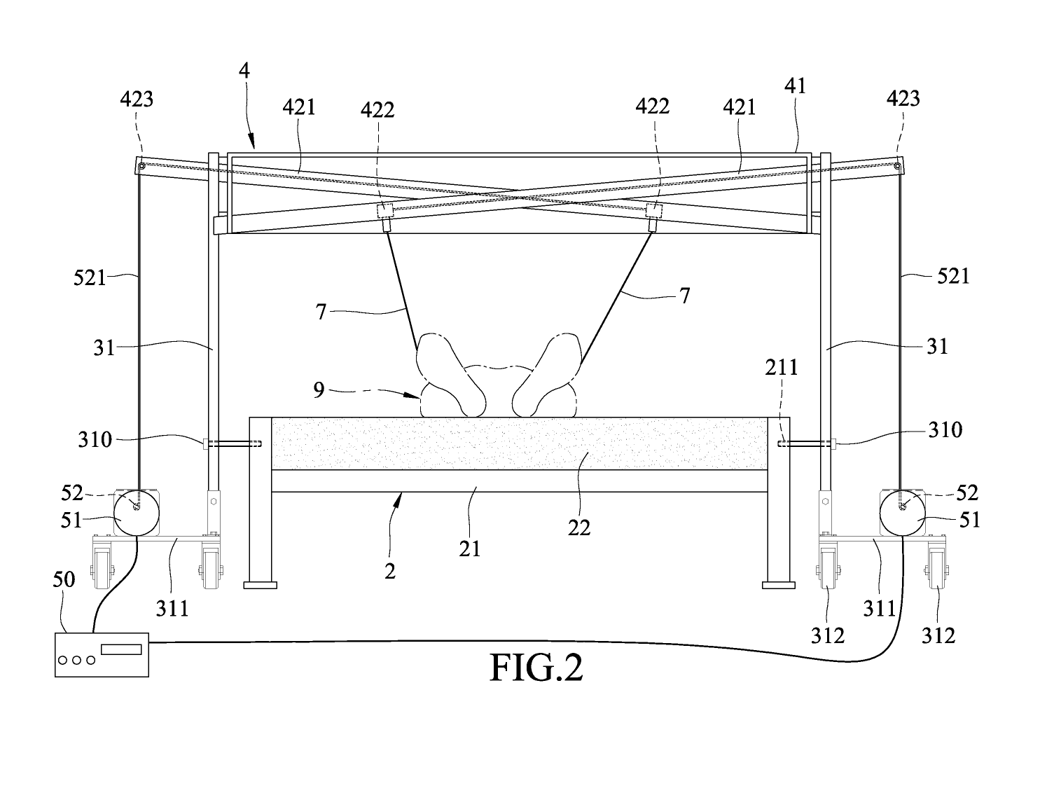

Referring to FIGS. 1 and 2, a pull-type body turning device according to a first embodiment of the present disclosure includes a bed assembly 2 and a pull-type body turning aid. The pull-type body turning aid includes a support assembly, a slide rail unit 4, a drive mechanism 5, a strap assembly 6 and two rope members 7.

The bed assembly 2 includes a rectangular bed frame 21, and a mattress 22 disposed on the bed frame 21 for a patient 9 to lie thereon. In this embodiment, the bed frame 21 is a bed frame of a medical bed, but is not limited thereto. As long as the support assembly and the slide rail unit 4 can be assembled therewith, any type of bed frame is acceptable. The bed frame 21 has left and right sides each of which is formed with a plurality of spaced-apart engaging grooves 211 (only one is visible in FIG. 2).

The support assembly includes two support frames 31 respectively disposed on left and right sides of the bed frame 21, two fixing members 310 respectively extendable through the support frames 31 to engage a selected one of the engaging grooves 211 in the bed frame 21, two sliding seats 311 respectively disposed on bottom ends of the support frames 31, and a plurality of positioning wheels 312 disposed on bottom ends of the sliding seats 311. The support frames 31 are configured to be slidable along a body height direction of the patient 9 (the body height direction refers to the direction from head to foot or foot to head of the patient 9) through the positioning wheels 312. When the support frames 31 are moved to a desired position relative to the patient 9, the positioning wheels 312 are forced to stop, and the fixing members 310 are inserted through the support frames 31 to engage the selected ones of the engaging grooves 211 in the bed frame 21 so as to fix the support frames 31 on the bed frame 21.

The slide rail unit 4 is supported by the support frames 31, and is configured to be located above and corresponding to a position between shoulders and hips of the patient 9. The slide rail unit 4 includes a casing 41 and two spaced-apart slide rail assemblies 42 disposed in the casing 41.

Each slide rail assembly 42 includes a slide rail 421, a sliding block 422 and a pulley 423. The slide rail 421 has a length configured to extend across the patient 9, and has one end that extends through one lateral side of the casing 41, that is connected to a respective one of the support frames 31 and that is configured to be proximate to the patient 9, and the other opposite end that is configured to be distal from the patient 9, that extends through the other opposite lateral side of the casing 41 and that is higher than the one end thereof. The sliding block 422 is disposed in the slide rail 421 and is slidable along the length of the slide rail 421. The pulley 423 is mounted on the other opposite end of the slide rail 421 that is distal from the patient 9. Specifically, the slide rails 421 of the slide rail assemblies 42 are inclined relative to each other.

The drive mechanism 5 of this embodiment includes two motors 51 respectively disposed on the sliding seats 311, two cable winding devices 52 respectively disposed on and connected to the motors 51, and two cables 521 each of which is wound and unwound on a respective one of the cable winding devices 52. Each cable 521 has one end passing around the pulley 423 of a respective one of the slide rail assemblies 42 and connected to the sliding block 422 of the respective slide rail assembly 42. By activating each motor 51, each of the cable winding devices 52 is driven by a respective one of the motors 51 to wind a respective one of the cables 521 and pull the sliding block 422 of the respective slide rail assembly 42 to slide from a low position, which is proximate to the one end of the slide rail 421 and the patient 9, to a high position, which is proximate to the other end of the slide rail 421 and distal from the patient 9. When each cable winding device 52 is driven by the respective motor 51 to unwind and release the respective cable 521, the sliding block 422 will slide from the high position to the low position due to its own weight, and each cable 521 is unwound from the respective cable winding device 52.

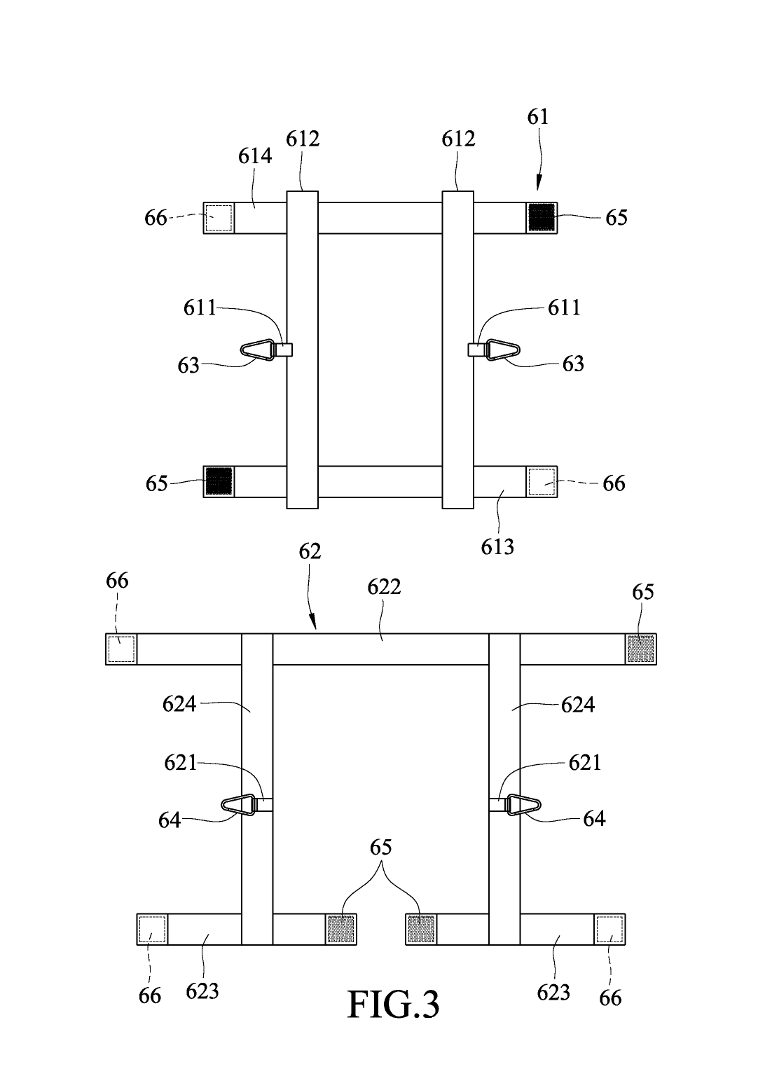

Referring to FIG. 3, in combination with FIG. 1, the strap assembly 6 is configured to be worn on the patient 9, and includes an upper body strap unit 61 configured to secure the upper body of the patient 9, and a lower body strap unit 62 configured to secure the lower body of the patient 9. Each of the upper and lower body strap units 61, 62 may be provided with fastening structures, such as button and hole fasteners, buckle and ring fasteners, hook and loop fasteners 65, magnetic fasteners, etc., so as to be arbitrarily worn on or remove from the patient 9.

In this embodiment, the upper body strap unit 61 includes two spaced-apart shoulder straps 612 configured to be disposed on the shoulders of the patient 9, two shoulder pulling portions 611 respectively disposed on the shoulder straps 612, two shoulder rings 63 respectively disposed on the shoulder pulling portions 611, a front strap 613 connected to front ends of the shoulder straps 612 and having hook and loop fasteners 65, 66 sewn on two opposite ends thereof, and a rear strap 614 connected to rear ends of the shoulder straps 612 and having hook and loop fasteners 65, 66 sewn on two opposite ends thereof. When the upper body strap unit 61 is slipped on the upper body of the patient 9, the hook and loop fasteners 65, 66 of the front strap 613 are respectively engaged with the hook and loop fasteners 65, 66 of the rear strap 614 to secure the upper body strap unit 61 on the upper body of the patient 9.

The lower body strap unit 62 includes a waist strap 622 having hook and loop fasteners 65, 66 sewn on two opposite ends thereof, two spaced-apart thigh straps 623 each of which has hook and loop fasteners 65, 66 sewn on two opposite ends thereof, two intermediate straps 624 each of which is connected between the waist strap 622 and a corresponding one of the thigh straps 623, two hip pulling portions 621 respectively disposed on the intermediate straps 624, and two hip rings 64 respectively disposed on the hip pulling portions 621. Each hip pulling portion 621 is located at a respective one of the left and right sides of the patient 9 between the waist and the hips thereof. The hook and loop fasteners 65, 66 of the waist strap 622 are engaged with each other to secure on the waist of the patient 9, while the hook and loop fasteners 65, 66 of each thigh strap 623 are engaged with each other to secure on each of the thighs of the patient 9. Through this, the lower body strap unit 62 can be secured on the lower body of the patient 9.

It should be noted that the upper and lower body strap units 61, 62 can be made from any material, and the upper and lower body strap units 61, 62 may be dispensed herewith. In this case, the shoulder rings 63 and the hip rings 64 can be directly sewn on the clothes of the patient 9 at corresponding positions. As long as the strength of the material is sufficient to support the patient 9, any material is acceptable. The shoulder rings 63 and the hip rings 64 may be conventional rings, the purpose of which is to facilitate connection of the rope members 7 therewith. Therefore, there is no limitation as to the material, shape and structure of the shoulder rings 63 and the hip rings 64.

Referring back to FIGS. 1 and 2, each of the rope members 7 has a shoulder connection end 71 connected to a respective one of the shoulder rings 63, and a hip connection end 72 opposite to the shoulder connection end 71 and connected to a respective one of the hip rings 64 after passing through the sliding block 422 of the respective slide rail assembly 42. Specifically, one of the rope members 7 is connected to the shoulder ring 63 and the hip ring 64 located at the left side of the patient 9, and the other one of the rope members 7 is connected to the shoulder ring 63 and the hip ring 64 located at the right side of the patient 9. In this embodiment, each rope member 7 is made of nylon because the strength of nylon is sufficient to pull and lift the patient 9 and has a soft surface to avoid scratching the patient 9. However, the material of each rope member 7 is not limited thereto, as long as it has sufficient strength, any material is acceptable.

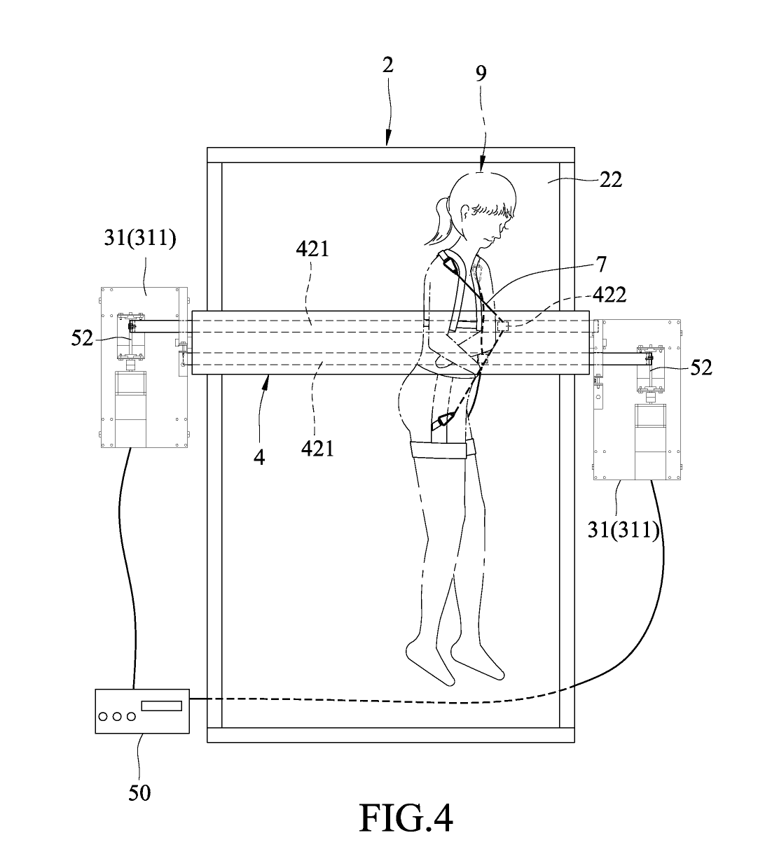

Referring to FIG. 4, in combination with FIGS. 1 and 2, by moving the sliding block 422 and pulling the rope member 7, the patient 9 can be driven to turn sideways. When the cable winding device 52 disposed on the right side of the bed frame 21 is driven by the respective motor 51 to wind the respective cable 521 and move the sliding block 422 from a left side, as shown in FIG. 2, to a right side, as shown in FIG. 4, the left rope member 7 shown in FIG. 2 will pull the patient 9 to turn and move toward the right side. As the sliding block 422 is continuously moved toward the right side, the patient 9 is continuously pulled until it is turned to a lateral decubitus position, and is stopped, as shown in FIG. 4. It is worth to mention herein that, when the patient 9 is turned to the lateral decubitus position, the patient 9 is pulled and positioned by the left rope member 7, and will not be continuously turned from the lateral decubitus position to the prone position. Through this, excessive turning of the patient 9 is restricted so as to prevent the nose and mouth of the patient 9 from being covered by the mattress 22 to cause suffocation. To turn the patient 9 back to the original supine or lying position, the motor 51 is reversed to loosen the right cable winding device 52, so that the sliding block 422 by its own weight can move back to its original position. Likewise, when the cable winding device 52 disposed on the left side of the bed frame 21 is driven by the respective motor 51 to wind the respective cable 521 and move the sliding block 422 from the right side, as shown in FIG. 2, to the left side, as shown in FIG. 4, the right rope member 7 shown in FIG. 2 will pull the patient 9 to turn and move toward the left side. Similar steps as described above are followed to position the patient 9 from the supine position to the other lateral decubitus position and to turn the patient 9 hack to the supine or lying position.

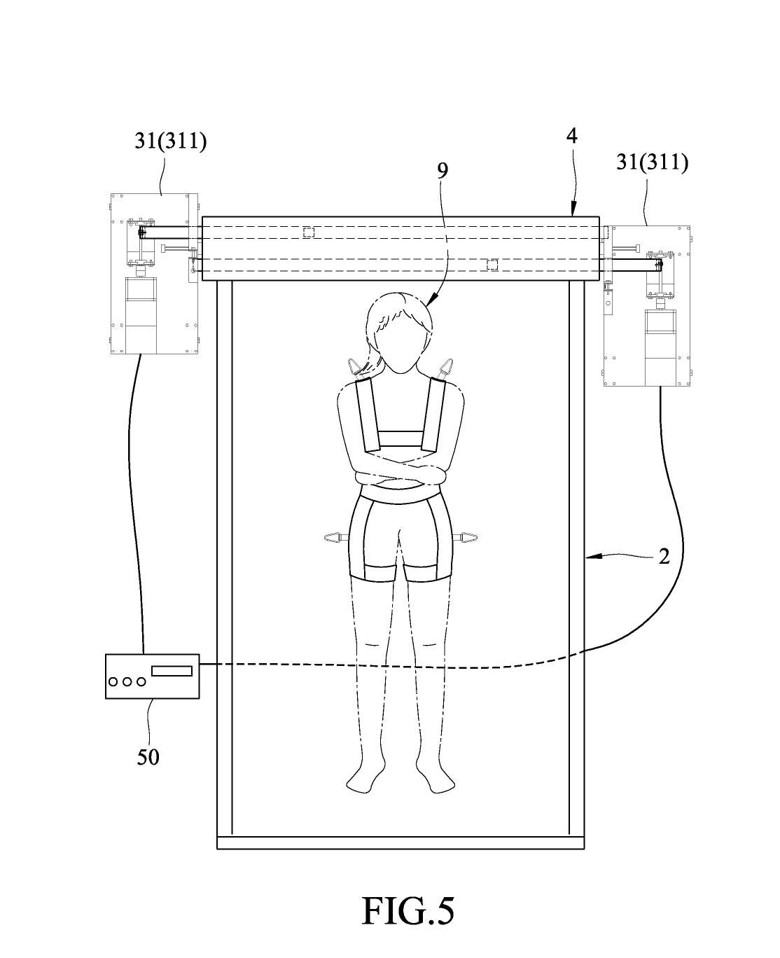

Referring to FIG. 5, in combination with FIG. 2, the slide rail unit 4 can be moved toward a rear end of the bed frame 21 through the sliding movement of the support frames 31. Before the slide rail unit 4 is moved, the rope members 7 (see FIG. 1) are first released and removed from the strap assembly 6 in order to prevent the patient 9 from being pulled during movement of the slide rail unit 4. Afterwards, the fixing members 310 are released from the corresponding engaging grooves 211 in the bed frame 21 so as to detach the support frames 31 from the bed frame 21, the positioning wheels 312 are unlocked to freely rotate on the ground, and the support frames 31 together with the slide rail unit 4 are pulled to move toward the rear end of the bed frame 21, as shown in FIG. 5, and away from the patient 9. Hence, an unobstructed space is formed above the patient 9 to facilitate a medical person or a healthcare provider in examining, treating or caring the patient 9.

In this embodiment, the drive mechanism 5 further includes a controller 50 electrically coupled to the motors 51. The controller 50 can be set to control the operation of each motor for driving the sliding movement of the sliding block 422 of each slide rail assembly 42 relative to the respective slide rail 421. As such, turning the patient 9 of different body type can be effectively performed. Further, a time for turning the patient 9 can also be set using the controller 50, so that there is no need for the healthcare provider to manually turn the patient 9. Hence, the labor cost can be saved.

From the aforesaid description, the advantages of this disclosure can be summarized as follows:

1. The sliding block 422 of each slide rail assembly 42 can be driven to move along the length of the slide rail 421 through the respective cable 521 and can be connected to the patient 9 through the respective rope member 7. As such, when the sliding block 422 of each slide rail assembly 42 is driven by the drive mechanism 5 to slide from one side to the other side of the patient 9, turning of the patient 9 can be performed, and there is no need for the healthcare provider to personally and manually turn the patient 9, thereby saving the labor cost.

2. After the patient 9 is turned to the lateral decubitus position, the patient 9 cannot be excessively turned from the lateral decubitus position to the prone position due to the restriction of the length of the corresponding rope member 7 so as to prevent the nose and mouth of the patient 9 from being covered by the mattress 22 to cause suffocation.

3. Because the slide rail unit 4 can move away from the patient 9 through the sliding movement of the support frames 31 so as to form an unobstructed space above the patient 9, the medical person or the healthcare provider can conveniently examine, treat or care the patient 9.

4. By using the controller 50 to set the time for turning the patient 9 to the lateral decubitus position or the supine position, there is no need for the healthcare provider to personally and manually turn the patient 9. Hence, the labor cost can be saved.

5. By using the present disclosure to turn the patient 9 to the lateral decubitus position, the healthcare provider can easily clean the body of the patient 9, such as wiping the back of the patient 9 or changing the patient's clothes or diapers.

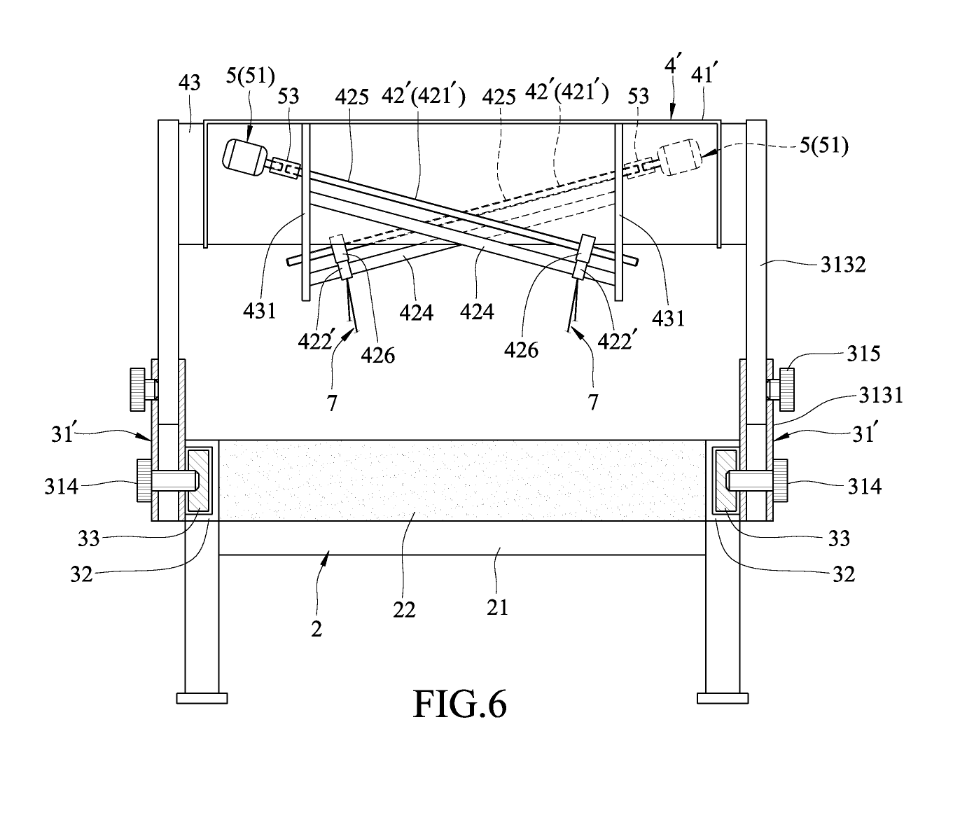

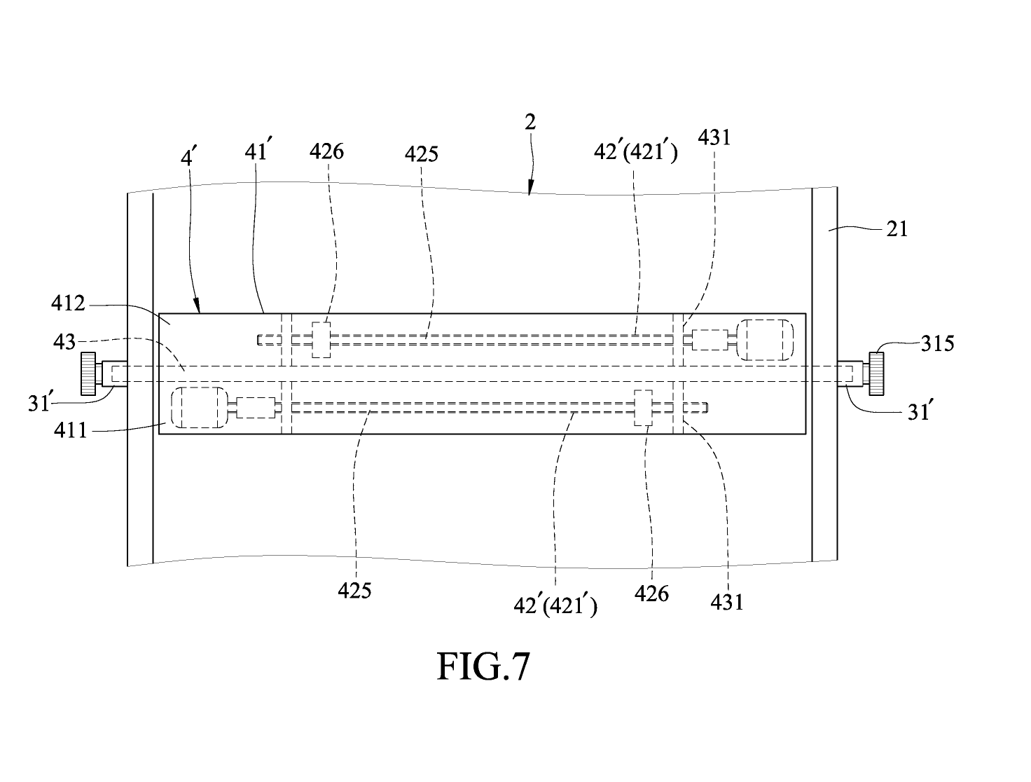

FIGS. 6 and 7 illustrate a pull-type body turning device according to a second embodiment of the present disclosure, which has a structure generally similar to that of the first embodiment. However, in this embodiment, the support assembly further includes two support rails 32 and two sliding members 33. The support rails 32 are respectively formed in the left and right sides of the bed frame 21 and extend along the lengths thereof or in a direction parallel to a body height direction of the patient 9. The support rails 32 are configured to be disposed on two opposite sides of the patient 9, respectively. The sliding members 33 are disposed respectively and slidably on the support rails 32. The sliding seats 311 (see FIG. 1) and the positioning wheels 312 (see FIG. 2) of the support assembly, which are disposed on the bottom ends of the support frames 31, are omitted herein.

In this embodiment, each of the support frames 31′ is configured as a telescopic tube including an outer tube 3131, an inner tube 3132 telescopically connected to the outer tube 3131, two first fasteners 314 and two second fasteners 315. Each of the first fasteners 314 is used to fix a lower end of the outer tube 3131 of each telescopic tube to a respective one of the sliding members 33 by extending each first fastener 314 through the lower end of the outer tube 3131 and engaging the respective sliding member 33. Through this, each support frame 31′ is slidable along with the respective sliding member 33 in a respective one of the support rails 32. Each of the second fasteners 315 is used for adjusting the length of the inner tube 3132 relative to the outer tube 3131.

The slide rail unit 4′ further includes a partition plate 43 and two pairs of holding members 431. The partition plate 43 extends downwardly from a top inner surface of the casing 41′ to divide the casing 41′ into two casing sections 411, 412, and has two opposite ends respectively inserted into top ends of the inner tubes 3132 of the telescopic tubes or support frames 31′. Each pair of the holding members 431 extend downwardly from the top inner surface of the casing 41′ into a respective one of the casing sections 411, 412, are spaced apart from each other, and are connected to a corresponding one side of the partition plate 43. In this embodiment, the slide rails 421′ of the slide rail assemblies 42′ are respectively disposed in the casing sections 411, 412, are respectively supported by the pairs of the holding members 431, and are inclined relative to each other.

Each slide rail 421′ of this embodiment includes an elongated rod 424, a threaded rod 425 and a threaded sleeve 426. The elongated rod 424, as shown in FIG. 6, has an upper end fixed to a top end portion of one of the pair of the holding members 431, and a lower end fixed to a bottom end portion of the other one of the pair of the holding members 431. The threaded rod 425 is parallel with the elongated rod 424, and has an upper end extending through the top end portion of the one of the pair of the holding members 431, and a lower end extending through the bottom end portion of the other one of the pair of the holding members 431. The threaded sleeve 426 is threadedly connected to the threaded rod 425. In this embodiment, the sliding block 422 is slidably sleeved on the elongated rod 424, and is connected to the threaded sleeve 426. The threaded s leave 426 and the sliding block 422′ are integrally formed as one piece, but are not limited thereto.

The drive mechanism 5 further includes two shaft couplings 53 each of which connects a respective one of the motors 51 to the upper end of the threaded rod 425 of the respective slide rail assembly 42′. When each of the motors 51 is activated, it can drive the threaded rod 425 of the respective slide rail assembly 42′ to rotate in a clockwise or counterclockwise direction. The threaded rod 425, in turn, can drive the threaded sleeve 426 together with the sliding block 422 to threadedly move along the length thereof when it is rotated by a respective one of the motors 51.

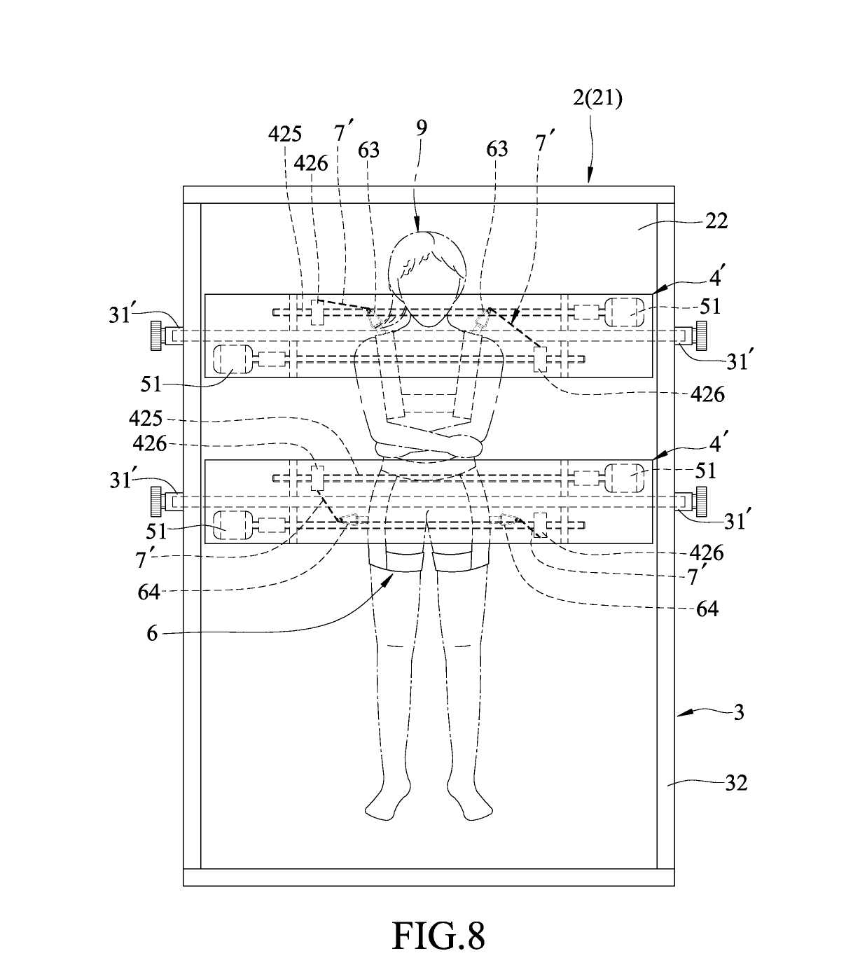

FIG. 8 illustrates a pull-type body turning device according to a third embodiment of the present disclosure. The pull-type body turning device of this embodiment includes a bed assembly 2 and a pull-type body turning aid. The pull-type body turning aid includes a support assembly, two slide rail units 4′, two drive mechanisms 5, and four rope members 7′. The operation of the components of this embodiment is generally similar to that described in the second embodiment.

The support assembly of this embodiment includes two support rails 32 respectively formed in the left and right sides of the bed frame 21, two pairs of sliding members 33, each pair of which are disposed respectively and slidably on the support rails 32, and two pairs of support frames 31′, each pair of which are disposed on the left and right sides of the bed frame 21. Each pair of the support frames 31′ are connected to a respective pair of the sliding members 33 so as to be slidable along with the respective pair of the sliding members 33 in the support rails 32. The structure of each support frame 31′ is similar to that described in the second embodiment.

The casings 41′ of the slide rail units 4′ are configured to be located above and corresponding to hips and shoulders of the patient 9, respectively. Two opposite ends of the partition plate 43 (see FIG. 6) extending from the casing 41′ of a respective one of the slide rail units 4′ are respectively connected to one of the pairs of the support frames 31′. Through this, each slide rail unit 4′ can move along with the corresponding pair of the support frames 31′. Generally, the structure and arrangement of each of the slide rail units 4′ of this embodiment are identical to those of the slide rail unit 4′ described in the second embodiment.

Each drive mechanism 5 of this embodiment includes two motors 51 disposed in the casing 41′ of corresponding one of the slide rail units 4′, and two shaft couplings 53 each of which connects one of the motors 51 to the threaded rod 425.

Two rope members 7′ are disposed in the casing 41′, which corresponds in position to the shoulders of the patient 9, and each of these rope members 7′ is connected between the sliding block 422′ (see FIG. 6) and a respective one of the shoulder rings 63 of the strap assembly 6. Another two rope members 7′ are disposed in the casing 41′, which corresponds in position to the hips of the patient 9, and each of these rope members 7′ is connected between the sliding block 422′ (see FIG. 6) and a respective one of the hip rings 64 of the strap assembly 6. By operating the motors 51 of the drive mechanisms 5, which are located at the same side of the patient 9, the threaded sleeves 426 together with the sliding blocks 422′ of the slide rail units 4′, which are located at the same side of the motors 51, are driven to move threadedly along the lengths of threaded rods 425, and one of the rope members 7′ connected to the respective shoulder ring 63 and the corresponding rope member 7′ connected to the hip ring 64 will simultaneously pull the patient 9 to turn and move from a supine position to a lateral decubitus position.

In addition, each of the slide rail units 4′ can move along with the corresponding pair of the support frames 31′, so that the slide rail units 4′ can be moved toward the front and rear ends of the bed frame 21, respectively, and away from the patient 9. As such, the medical person or the healthcare provider can conveniently examine, treat or care the patient 9. Aside from achieving the same advantages of the second embodiment, and apart from being capable of performing smooth turning of the patient 9, because the load can be distributed to the two slide rail units 4′, the pull-type body turning device of the third embodiment can further prevent damage of the support assemblies due to excessive load.

To sum up, because the patient 9 can be pulled and turned through the movement of the sliding blocks 422 of the present disclosure, the healthcare provider does not have to personally and manually turn the patient 9, so that the labor cost can be saved. Hence, the object of this disclosure can be realized.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A pull-type body turning aid for turning a patient, comprising:
at least one slide rail unit configured to be disposed above the patient and having at least one slide rail assembly, said slide rail assembly including a slide rail having a length configured to extend across the patient, and a sliding block slidable along said slide rail and configured to be connected to one side of the patient; and
a drive mechanism connected to said slide rail assembly and configured to drive said sliding block to move along said slide rail from the one side of the patient to the other side thereof for turning the patient to the other side thereof.

2. The pull-type body turning aid as claimed in claim 1, wherein said slide rail unit includes two said slide rail assemblies, said slide rail of each of said slide rail assemblies having one end configured to be proximate to the patient, and the other opposite end configured to be distal from the patient and higher than said one end, said slide rails of said slide rail assemblies being inclined relative to each other.

3. The pull-type body turning aid as claimed in claim 1, further comprising a strap assembly configured to be worn on the patient, and at least one rope member connected to said sliding block and said strap assembly.

4. The pull-type body turning aid as claimed in claim 3, wherein:
said strap assembly includes an upper body strap unit configured to secure the upper body of the patient, and a lower body strap unit configured to secure the lower body of the patient, said upper body strap unit including at least one shoulder pulling portion, said lower body strap unit including at least one hip pulling portion, said shoulder pulling port ion and said hip pulling portion being configured to be disposed at a same side of the patient; and
said rope member is connected to said shoulder pulling portion and said hip pulling portion.

5. The pull-type body turning aid as claimed in claim 4, wherein:
said upper body strap unit further includes two shoulder straps, one of which having said shoulder pulling portion, at least one shoulder ring disposed on said shoulder pulling portion and connected to said rope member, a front strap connected to front ends of said shoulder straps, and a rear strap connected to rear ends of said shoulder straps;
said lower body strap unit further includes a waist strap, two thigh straps, and two intermediate straps each of which is connected between said waist strap and a corresponding one of said thigh straps, one of said intermediate straps having said hip pulling portion; and
said lower body strap unit further includes at least one hip ring disposed on said hip pulling portion and connected to said rope member.

6. The pull-type body turning aid as claimed in claim 1, wherein said slide rail unit is configured to be located above and corresponding to a position between shoulders and hips of the patient.

7. The pull-type body turning aid as claimed in claim 1, wherein said slide rail unit includes two slide rail units that are spaced apart from each other, said slide rail units being configured to be located above and corresponding to shoulders and hips of the patient, respectively.

8. The pull-type body turning aid as claimed in claim 1, wherein said drive mechanism includes at least one cable winding device, and a cable wound and unwound on said cable winding device and connected to said sliding block.

9. The pull-type body turning aid as claimed in claim 8, wherein said cable winding device includes a plurality of cable winding devices disposed on two opposite sides of said slide rail assembly.

10. The pull-type body turning aid as claimed in claim 8, wherein:
said slide rail assembly further includes a pulley disposed on said slide rail;
said drive mechanism further includes at least one motor;
said cable winding device is connected to said motor; and
said cable passes around said pulley to connect with said sliding block.

11. The pull-type body turning aid as claimed in claim 10, further comprising a support assembly which includes two support frames configured to be located respectively on two opposite sides of the patient to support said slide rail unit, said pulley being mounted on one end of said slide rail.

12. The pull-type body turning aid as claimed in claim 11, wherein said motor includes two motors, and said cable winding device includes two cable winding devices respectively connected to said motors, said drive mechanism further including a controller electrically coupled to said motors for controlling operations of said motors.

13. The pull-type body turning aid as claimed in claim 12, wherein said support assembly further includes two sliding seats respectively disposed on bottom ends of said support frames, and a plurality of positioning wheels disposed on bottom ends of said sliding seats, said support frames being configured to be movable along a body height direction of the patient, said motors being disposed on said support assembly.

14. The pull-type body turning aid as claimed in claim 1, wherein said slide rail includes an elongated, rod, and said sliding block is slidably sleeved on said elongated rod.

15. The pull-type body turning aid as claimed in claim 1, wherein said slide rail includes a threaded rod and a threaded sleeve threadedly connected to said threaded rod and connected to said sliding block, said drive mechanism including at least one motor connected to said threaded rod for driving rotation of said threaded rod, said threaded rod driving said threaded sleeve to threadedly move along the length thereof when said threaded rod is rotated.

16. The pull-type body turning aid as claimed in claim 15, wherein said slide rail further includes an elongated rod parallel with said threaded rod, and said sliding block is slidably sleeved on said elongated rod.

17. The pull-type body turning aid as claimed in claim 1, further comprising a support assembly including two support frames configured to be located respectively on two opposite sides of the patient to support said slide rail unit.

18. The pull-type body turning aid as claimed in claim 17, wherein said support assembly further includes two support rails configured to extend in a direction parallel to a body height direction of the patient and configured to be disposed on two opposite sides of the patient, respectively, said support frames being connected respectively and slidably to said support rails.

19. The pull-type body turning aid as claimed in claim 18, wherein said support assembly further includes two sliding members disposed respectively and slidably on said support rails.

20. The pull-type body turning aid as claimed in claim 17, wherein each of said support frames is configured as a telescopic tube.

21. A pull-type body turning device for turning a patient, comprising:
a bed assembly configured to support the patient; and
a pull-type body turning aid movable relative to said bed assembly and including
at least one slide rail unit configured to be disposed above the patient and having at least one slide rail assembly, said slide rail assembly including a slide rail having a length configured to extend across the patient, and a sliding block slidable along said slide rail and configured to be connected to one side of the patient, and
a drive mechanism connected to said slide rail assembly and configured to drive said sliding block to move along said slide rail from the one side of the patient to the other side thereof for turning the patient to the other side thereof.

22. The pull-type body turning device as claimed in claim 21, wherein said bed assembly includes a bed frame, said pull-type body turning aid further including a support assembly, said support assembly including two support frames respectively disposed on left and right sides of said bed frame to support said slide rail unit.

23. The pull-type body turning device as claimed in claim 22, wherein:
said support assembly further includes two support rails that are configured to extend in a direction parallel to a body height direction of the patient and that are respectively disposed on the left and right sides of said bed frame; and
said support frames are connected respectively and slidably to said support rails.

24. The pull-type body turning device as claimed in claim 23, wherein said support assembly further includes two sliding members disposed respectively and slidably on said support rails.

25. The pull-type body turning device as claimed in claim 22, each of said support frames is configured as a telescopic tube.

26. The pull-type body turning device as claimed in claim 22, wherein:
said support assembly further includes two sliding seats respectively disposed on bottom ends of said support frames, and a plurality of positioning wheels disposed on bottom ends of said sliding seats, said support frames being configured to be slidable along the body height direction of the patient; and
said drive mechanism includes at least one motor disposed on said support assembly, and a controller electrically coupled to said motor for controlling operation of said motor.

27. The pull-type body turning device as claimed in claim 22, wherein said support assembly further includes two fixing members disposed respectively and removably on said support frames to engage said bed frame.

28. The pull-type body turning device as claimed in claim 21, wherein said pull-type body turning aid includes two said slide rail units that are spaced apart from each other, said slide rail units being configured to be located above and corresponding to shoulders and hips of the patient, respectively.
